(19) United States
(12) Patent Application Publication
(10) Pub. No.: US 2022/0128233 A1
(43) Pub. Date: Apr. 28, 2022

(54) HYGIENIC BIRTHDAY CELEBRATION CANDLE APPARATUS

(71) Applicants: Denise Millington, Scottsdale, AZ (US); Dora Godnig, East Stroudsburg, PA (US)

(72) Inventors: Denise Millington, Scottsdale, AZ (US); Dora Godnig, East Stroudsburg, PA (US)

(21) Appl. No.: 17/081,504

(22) Filed: Oct. 27, 2020

(51) Int. Cl. F21V 35/00; A47G 19/30

(52) U.S. Cl. CPC F21V 35/006; F21W 2121/002; A47G 19/30

(57) ABSTRACT

A faux birthday cake apparatus having in one example a flexible base that is indicative of a cake has a plurality of recesses configured to receive candles. The base can be bent or twisted to eject any wax drippings resulting from the candles. The upper surface of the base has a continuous central portion including indicia, such as a message indicative of a celebration. In another example, the apparatus has a base including a lower portion supporting an upper portion having a plurality of recesses configured to receive candles. A selectively removable flexible sheet-like layer is disposed on the upper portion and has openings aligned with the plurality of recesses. After a celebration, any wax drippings that fall on the sheet-like layer can be easily ejected by bending or twisting the sheet-like layer. The materials are all dishwasher safe.

### TECHNICAL FIELD

The present subject matter relates to devices for personal celebrations.

### BACKGROUND

Traditional edible cakes used for personal celebrations, such as for birthdays, anniversaries, and so forth typically have an upper portion or layer suitable for receiving a plurality of candles. After a presentation, such as singing a birthday song, telling stories, making a wish and so forth, the person being celebrated blows out all the candles, in one breath if possible to avoid shame, ridicule and other personal salutations. However, such traditional celebrations spread germs across the cake that are undesirable to be shared with others, especially in the relevant time including the Covid-19 disease.

### BRIEF DESCRIPTION OF THE DRAWINGS

The drawing figures depict one or more implementations, by way of example only, not by way of limitations. In the figures, like reference numerals refer to the same or similar elements.

FIG. 1 is a perspective view of first embodiment of a faux cake apparatus illustrating a plurality of candles and a central portion for providing a celebration message;

FIG. 2 is a top view of the apparatus of FIG. 1;

FIG. 3 is a cross sectional view of the apparatus taken along line A-A in FIG. 2:

FIG. 4 is a front side view of the apparatus of FIG. 1;

FIG. 5 is a left side view of the apparatus of FIG. 1;

FIG. 6 is a side view of the inverted apparatus of FIG. 1;

FIG. 7 is a bottom view of the apparatus of FIG. 1;

FIG. 8 is a perspective view of a second embodiment of a faux cake apparatus illustrating a plurality of candles and a central portion for providing a celebration message;

FIG. 9 is a top view of the apparatus of FIG. 8;

FIG. 10 is a cross sectional view of the apparatus taken along line B-B in FIG. 9;

FIG. 11 is a front side view of the apparatus of FIG. 8:

FIG. 12 is a left side view of the apparatus of FIG. 8;

FIG. 13 is a right side view of the apparatus of FIG. 8; and

FIG. 14 is a right side view of the inverted apparatus of FIG. 8.

### DETAILED DESCRIPTION

This disclosure includes examples of a faux birthday cake. In one example, the apparatus has a flexible base that is indicative of a cake has a plurality of recesses configured to receive candles. The base can be bent or twisted to eject any wax drippings resulting from the candles. The upper surface of the base has a continuous central portion including indicia, such as a message indicative of a celebration. In another example, the apparatus has a base including a lower portion supporting an upper portion having a plurality of recesses configured to receive candles. A selectively removable flexible sheet-like layer is disposed on the upper portion and has openings aligned with the plurality of recesses. After a celebration, any wax drippings that fall on the sheet-like layer can be easily ejected by bending or twisting the sheet-like layer. The materials are all dishwasher safe.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

The orientations of the eyewear device, associated components and any complete devices incorporating an eye scanner and camera such as shown in any of the drawings, are given by way of example only, for illustration and discussion purposes. In operation for a particular variable optical processing application, the eyewear device may be oriented in any other direction suitable to the particular application of the eyewear device, for example up, down, sideways, or any other orientation. Also, to the extent used herein, any directional term, such as front, rear, inwards, outwards, towards, left, right, lateral, longitudinal, up, down, upper, lower, top, bottom and side, are used by way of example only, and are not limiting as to direction or orientation of any optic or component of an optic constructed as otherwise described herein.

Reference now is made in detail to the examples illustrated in the accompanying drawings and discussed below.

FIG. 1 is a perspective view of a faux cake apparatus at 10 that is representative of an edible cake, such as a birthday cake. Apparatus 10 comprises a base portion 12 comprised of a resilient material such that it easily bends when bent by hands of a user, such as an elastomeric material including a closed foam, plastic and rubber. The base portion 12 has a geometric shape, such as round, oval, diamond, rectangular and limitation to the particular shape is not to be inferred. The base portion 12 may be a solid form, or formed as a frame or shell as shown in FIG. 3 illustrating a cross sectional view of the base portion 12. The base portion 12 has a continuous top surface 14 without openings encompassing the whole upper surface of apparatus 10 and having a plurality of uniformly spaced round recesses 16 configured to selectively and securely receive, and release, respective wax candles 18. The base portion 12 has a central portion 20 comprising a central flat surface 22 for receiving indicia including user created messages, greetings and so forth. The messages may be drawn on the central surface 22 using decorating techniques, such as using a marker, frosting, and also receive attachments adhered thereto and so forth. The central surface 22 may also include a selectively disposable accessory 24, such as a stand alone candle or figurine having the shape of a number(s), a character, a flower, a 3 dimensional member such as a graduation hat, a toy and so forth. The outer surface of the base portion 12 may include a portion 26 that is indicative of frosting, such has having lines indicative of a spreading knife or drippings.

After the celebration the candles 18 can be removed. The base portion 12 is formed of the resilient materials such that after burning the candles during the celebration, the entire base portion 12 can be bent and twisted so that wax remnants remaining from the melting candles 18 on the central portion 20 can be easily ejected or popped-off. The candles can be removed, and the base portion 12 can be easily cleaned and is dishwasher safe.

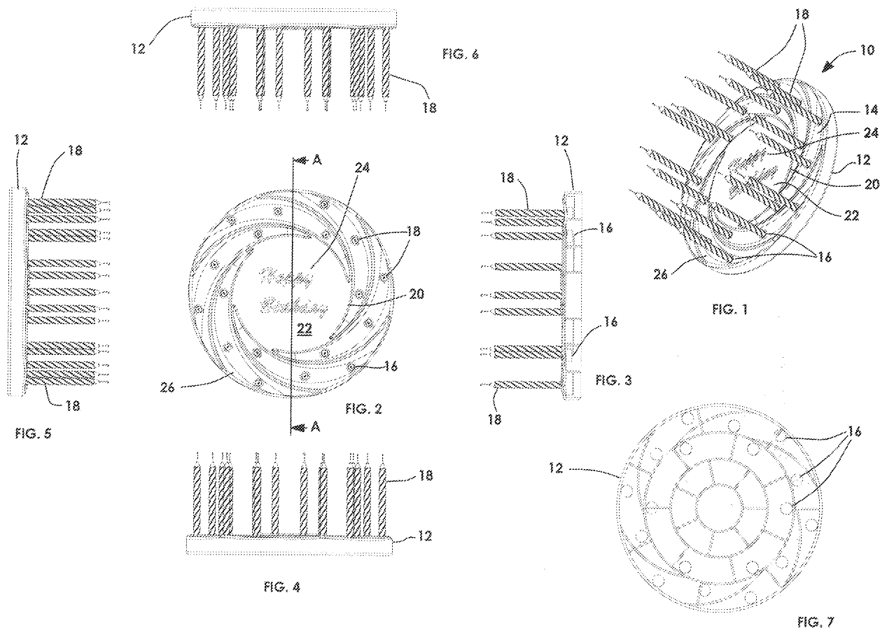

FIG. 2 is a top view of the apparatus of FIG. 1 illustrating a top view of the central surface 22 having a message displayed that is suitable for the occasion being celebrated. As shown, the top surface of apparatus 10 has a unique graphic custom design element 24, shown as a swirl in this embodiment.

FIG. 3 is a cross sectional view of the apparatus taken along line A-A in FIG. 2 illustrating the base portion 12 formed as a frame or shell. This figure also illustrates a side view of the recesses 16 for selectively and securely receiving the candles 18.

FIG. 4 is a front side view of the apparatus of FIG. 1.

FIG. 5 is a left side view of the apparatus of FIG. 1.

FIG. 6 is a side view of the inverted apparatus of FIG. 1.

FIG. 7 is a bottom view of the apparatus of FIG. 1.

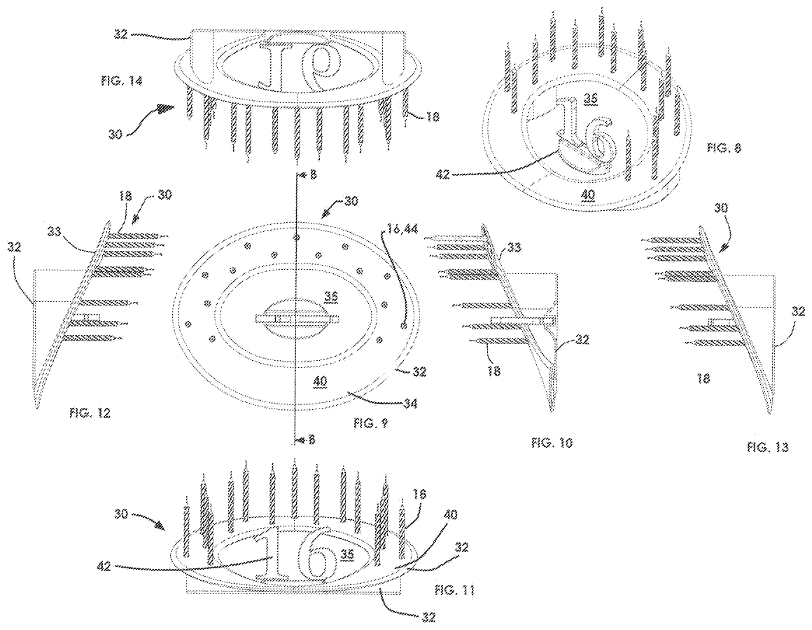

Referring now to FIG. 8, there is shown a second embodiment of the disclosure comprising a faux cake apparatus 30 having an L-shaped base portion 32 and an upper portion 33. The upper portion 33 has a geometric shape, such as a round or oval ring as shown forming an opening 35, and limitation to the particular shape is not to be inferred. The base portion 32 may be a solid form, or formed as a frame or shell as shown in FIG. 10 illustrating a cross sectional view of the base portion 32. The upper portion 33 has a top surface 34 having a plurality of uniformly spaced round recesses 36 configured to selectively and securely receive wax candles 18. An accessory 42 can be positioned in the center of opening 35 for display, such as larger candles or figurines having number(s) representing an age, or other desired features. The accessory 42 can be chromed to have an aesthetic appearance. The candles 18 can be removed from the respective recesses 36 after the celebration.

The upper portion 33 further includes a flexible, selectively removable, sheet-like layer 40 positioned on, and substantially or completely overlaying the top surface 34. The flexible layer 40 is thin and comprises of an elastomeric material such as a plastic. The flexible layer 40 has a plurality of openings 44 that are each positioned around the respective recesses 36 to allow the candles 18 to extend through the respective opening 44 and into the respective recess 36. The flexible layer 40 can be easily ejected or popped-off the top surface 34 by the user after the candles 16 are removed. The base portion 32 and the flexible layer 40 can each be easily cleaned and are dishwasher safe.

FIG. 9 is a top view of the apparatus 30 of FIG. 8 illustrating the top flexible selectively removable layer 40 positioned on the top surface 34 of the upper portion 33. The flexible layer 40 may have one or more colors, designs, and include indicia.

FIG. 10 is a cross sectional view of the apparatus taken along line B-B in FIG. 9.

FIG. 11 is a front side view of the apparatus of FIG. 8.

FIG. 12 is a left side view of the apparatus of FIG. 8.

FIG. 13 is a right side view of the apparatus of FIG. 8.

FIG. 14 is a right side view of the inverted apparatus of FIG. 8.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A faux cake apparatus, comprising:
a flexible base comprised of a resilient material and having an upper surface including a central portion;
a plurality of recesses formed in the upper surface of the base and configured to receive a candle;
a plurality of candles selectively coupled to the recesses; and
and indicia disposed on the central portion.

2. The faux cake apparatus as specified in claim 1, wherein the flexible base is round and representative of a cake.

3. The faux cake apparatus as specified in claim 1, wherein the upper surface is continuous without any openings.

4. The faux cake apparatus as specified in claim 1, further comprising a portion of the base member having the resemblance of frosting.

5. The faux cake apparatus as specified in claim 1, wherein the indicia is a message.

6. The faux cake apparatus as specified in claim 5, wherein the message is indicative of a celebration

7. The faux cake apparatus as specified in claim 1, wherein the base member comprises a shell.

8. The faux cake apparatus as specified in claim 1, wherein the faux cake apparatus is indicative of a birthday cake.

9. A faux cake apparatus, comprising:
a base portion supporting an upper portion having an upper surface;
a plurality of recesses formed in the upper surface configured to receive a candle;
a sheet-like layer disposed upon the upper surface and being selectively removable from the upper surface, the sheet-like layer having a plurality of openings corresponding to the plurality of recesses; and
a plurality of candles to extending through respective said openings into the recesses.

10. The faux cake apparatus as specified in claim 9, wherein the sheet-like layer is flexible and configured to eject any wax drippings from the candles when flexed.

11. The faux cake apparatus as specified in claim 9, wherein the upper portion is formed as a ring forming a central opening.

12. The faux cake apparatus as specified in claim 9, further comprising an accessory positioned in the central opening.

13. The faux cake apparatus as specified in claim 9, wherein the base portion forms an L-shape with the upper portion.

14. The faux cake apparatus as specified in claim 13, wherein the upper surface is angled with respect to horizontal when positioned on a horizontal surface.
